(19) United States
(12) Patent Application Publication
(10) Pub. No.: US 2026/0100392 A1
(43) Pub. Date: Apr. 9, 2026

(54) METHOD FOR MANUFACTURING REINFORCED COMPOSITE MEMBRANE AND REINFORCED COMPOSITE MEMBRANE OBTAINED THEREBY

(71) Applicant: KOREA INSTITUTE OF ENERGY RESEARCH, Daejeon (KR)

(72) Inventors: Byungchan BAE, Daejeon (KR); Dongwon SHIN, Sejong (KR); Hyejin LEE, Daejeon (KR); Young-jun SOHN, Daejeon (KR); Gu-gon PARK, Daejeon (KR); Tae-Hyun YANG, Daejeon (KR); Sung-dae YIM, Daejeon (KR); Seok-hee PARK, Daejeon (KR); Min-jin KIM, Daejeon (KR); Hwanyeong OH, Sejong (KR); Seung Hee WOO, Daejeon (KR); Sojeong LEE, Daejeon (KR); Yoon Young CHOI, Sejong (KR); Eun Jik LEE, Sejong (KR); Yun Sik KANG, Seongnam-si (KR); Yongmin KWON, Daejeon (KR); In Seop LIM, Seoul (KR); Aman PATHANIA, Daejeon (KR); Juniko Nur PRATAMA, Daejeon (KR); Won-yong LEE, Daejeon (KR)

(73) Assignee: KOREA INSTITUTE OF ENERGY RESEARCH, Daejeon (KR)

(21) Appl. No.: 19/077,491

(22) Filed: Mar. 12, 2025

(30) Foreign Application Priority Data
Oct. 7, 2024 (KR) 10-2024-0135479

(51) Int. Cl. H01M 8/1088; C25B 13/04; H01M 8/10; H01M 8/1025; H01M 8/1039

(52) U.S. Cl. CPC H01M 8/1088; C25B 13/04; H01M 8/1025; H01M 8/1039; H01M 2008/1095; H01M 2300/0082; H01M 2300/0094

(57) ABSTRACT

The present disclosure relates to a method for manufacturing a reinforced composite membrane and a reinforced composite membrane obtained thereby. The method for manufacturing a reinforced composite membrane can minimize a difference in hydrophilicity and hydrophobicity between a porous support and a hydrocarbon-based polymer electrolyte and can improve the impregnation property of a polymer electrolyte.

### CROSS-REFERENCE TO RELATED APPLICATION

This application claims priority to Korean Patent Application No. 10-2024-0135479, filed on Oct. 7, 2024, and all the benefits accruing therefrom under 35 U.S.C. § 119, the contents of which in its entirety are herein incorporated by reference.

### BACKGROUND

### 1. Field

The present disclosure relates to a method for manufacturing a reinforced composite membrane and a reinforced composite membrane obtained thereby.

### 2. Description of the Related Art

Recently, many attempts have been conducted to improve the performance and stability of an electrolyte membrane as a key part of a fuel cell so that the performance and stability of a fuel cell may be improved. Particularly, it is important to reduce resistance through thin filming of a polymer electrolyte membrane in order to improve the performance of a fuel cell.

Meanwhile, development of a block copolymer-type hydrocarbon-based polymer capable of competing Nafion, which is a fluorine-based polymer commercialized recently, has been made actively. Such a hydrocarbon-based polymer has a higher ratio of volume swelling caused by water and a lower elongation ratio as compared to a fluorine-based polymer electrolyte membrane, and thus a technology of manufacturing a reinforced composite membrane-type electrolyte membrane having a smaller thickness and capable of supplementing mechanical properties is essentially required. In addition, the hydrocarbon-based polymer electrolyte has an ion conducting functional group and is hydrophilic, while most of porous supports for manufacturing a reinforced composite membrane have strong hydrophobicity, and thus there is a limitation in that it is difficult to manufacture a uniform reinforced composite membrane.

### REFERENCES

### Patent Documents

[Patent Document 1] Korean Patent Laid-Open No. 10-2023-0160510

### SUMMARY

To solve the above-mentioned problems, the present disclosure is directed to providing a method for manufacturing a reinforced composite membrane, including the steps of: (A) pretreating a porous support; and (B) impregnating the pretreated porous support with a polymer electrolyte solution containing a solvent, a surfactant and a hydrocarbon-based polymer electrolyte, wherein said pretreating is carried out by at least one of a method of dipping the porous support in a pretreatment solution containing at least one of K₂Cr₂O₇ and KClO₄ and a plasma treatment method.

The present disclosure is also directed to providing a reinforced composite membrane obtained by the method for manufacturing a reinforced composite membrane.

In addition, the present disclosure is directed to providing a water electrolysis bath including the reinforced composite membrane.

In addition, the present disclosure is directed to providing a fuel cell including the reinforced composite membrane.

Further, the present disclosure is directed to providing a device including the fuel cell, the device being any one selected from communication devices, transport devices and energy storage devices.

In one aspect, there is provided a method for manufacturing a reinforced composite membrane, including the steps of: (A) pretreating a porous support; and (B) impregnating the pretreated porous support with a polymer electrolyte solution containing a solvent, a surfactant and a hydrocarbon-based polymer electrolyte, wherein said pretreating is carried out by at least one of a method of dipping the porous support in a pretreatment solution containing at least one of K₂Cr₂O₇ and KClO₄ and a plasma treatment method.

In another aspect, there is provided a reinforced composite membrane obtained by the method for manufacturing a reinforced composite membrane.

In still another aspect, there is provided a water electrolysis bath including the reinforced composite membrane.

In still another aspect, there is provided a fuel cell including the reinforced composite membrane.

In yet another aspect, there is provided a device including the fuel cell, the device being any one selected from communication devices, transport devices and energy storage devices.

The method for manufacturing a reinforced composite membrane according to the present disclosure can minimize a difference in hydrophilicity and hydrophobicity between a porous support and a hydrocarbon-based polymer electrolyte and can improve the impregnation property of a polymer electrolyte.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 is a schematic view illustrating the method for manufacturing a reinforced composite membrane according to an embodiment of the present disclosure.

FIG. 2 shows a water contact angle of non-treated polytetrafluoroethylene (PTFE), that of the pretreated porous support (PTFE-A) obtained according to Example 1 of the present disclosure, and that of the pretreated porous support obtained according to Example 2, depending on time.

FIG. 3 shows an image for measuring a water contact angle of non-treated polytetrafluoroethylene (PTFE), that of the pretreated porous support (PTFE-A) obtained according to Example 1 of the present disclosure, and that of the pretreated porous support obtained according to Example 2, at the initial stage (0 min) and after 60 minutes.

FIG. 4 shows a photographic image and haziness of the reinforced composite membrane obtained according to each of Comparative Examples 1 and 2 and Examples 1 to 4 of the present disclosure.

FIG. 5 shows a photographic image and haziness of the reinforced composite membrane obtained according to each of Comparative Example 3 and Examples 5 and 6 of the present disclosure.

FIG. 6 shows the result of measuring a contact angle to determine the wettability of PTFE with the polymer solution prepared from each of Examples 5 and 6 of the present disclosure.

FIG. 7 shows a photographic image of the polymer electrolyte solution according to each of Examples 7 to 10 of the present disclosure.

FIG. 8 shows a photographic image and haziness of the reinforced composite membrane according to each of Examples 7 to 10 and Comparative Example 4 of the present disclosure.

FIG. 9 shows a scanning electron microscopic (SEM) image of the reinforced composite membrane according to each of Example 6 and Comparative Example 1 of the present disclosure and PTFE.

### DETAILED DESCRIPTION

The advantages and features of the present disclosure and methods of achieving them will become clear with reference to the embodiments described hereinafter in detail with the accompanying drawings. However, the present disclosure is not limited to the embodiments described hereinafter and will be implemented in various different forms, the embodiments described hereinafter are provided only to ensure that the present disclosure is complete and to fully inform those skilled in the art to which the present disclosure pertains the scope of the present disclosure, and the present disclosure is only defined by the scope of the claims.

In the specification, if it is determined that detailed description of a related known technology may unnecessarily obscure the gist of the present disclosure, the detailed description thereof is omitted. If “including”, “having”, “formed of” or the like mentioned in the present specification is used, other parts may be added unless “only” is used. In addition, terms such as “including” or “having” are intended to specify that there is a feature, number, step, element or combination thereof described in the specification, and should not be understood as excluding the existence or the possibility of addition of one or more other features, numbers, steps, elements, or combinations thereof. Further, the case of expressing an element in a singular form includes the case of including the plural unless otherwise stated.

In one aspect, there is provided method for manufacturing a reinforced composite membrane, including the steps of: (A) pretreating a porous support; and (B) impregnating the pretreated porous support with a polymer electrolyte solution containing a solvent, a surfactant and a hydrocarbon-based polymer electrolyte, wherein said pretreating is carried out by at least one of a method of dipping the porous support in a pretreatment solution containing at least one of K₂Cr₂O₇ and KClO₄ and a plasma treatment method.

### (A) Step of Pretreating Porous Support

Step (A) is a step of pretreating a porous support.

The porous support may include at least one selected from the group consisting of polysulfone, polyarylene ether sulfone, polyarylene ether ketone, polybenzimidazole, polybenzoxazole, polybenzthiazole, polypyrrolone, polyether ether ketone, polyphosphazene, polytetrafluoroethylene (PTFE), polyethylene (PE), polyvinylidene fluoride (PVDF), polyethylene terephthalate (PET), polyimide (PI), polypropylene (PP), cellulose and nylon, preferably polytetrafluoroethylene (PTFE).

The porous support layer may have a thickness of 5-30 μm, preferably 5-20 μm.

When the porous support layer has a thickness of less than the lower limit, it may have degraded mechanical strength. On the other hand, when the thickness is larger than the upper limit, it cannot be impregnated uniformly with a polymer electrolyte and may have reduced ion conductivity.

The porous support layer may have a porosity of 40-90%, preferably 40-85%.

When the porous support layer has a porosity of less than the lower limit, it may have reduced ion conductivity. On the other hand, when the porous support layer has a porosity of larger than the upper limit, it may have reduced dimensional stability and durability.

The porous support layer may have a pore size of 0.02-0.80 μm, preferably 0.02-0.50 μm.

When the porous support layer has a pore size of less than the lower limit, it is not possible to impregnate the porous support layer easily with an electrolyte. On the other hand, when the porous support layer has a pore size of larger than the upper limit, it may have reduced dimensional stability and durability.

Said pretreating may be carried out by at least one of a method of dipping the porous support in a pretreatment solution containing at least one of K₂Cr₂O₇ and KClO₄ and a plasma treatment method.

The pretreatment solution may contain at least one of K₂Cr₂O₇ and KClO₄, preferably both K₂Cr₂O₇ and KClO₄.

Particularly, when said pretreating is carried out by the method of dipping the porous support in a pretreatment solution containing K₂Cr₂O₇ and KClO₄, it is shown that the porous support can maintain its porous property at the same level as the initial stage with no damages upon the porous support, while maximizing the hydrophilicity.

The pretreatment solution may contain at least one of K₂Cr₂O₇ and KClO₄ in an amount of 0.5-10.0 wt %, preferably 1.0-5.0 wt %, based on 100 wt % of the total weight of the pretreatment solution.

When the content of at least one of K₂Cr₂O₇ and KClO₄ in the pretreatment solution is less than the lower limit, chemical reaction of modifying the chemical structure of the porous support cannot be accomplished. On the other hand, when the content is larger than the upper limit, a lot of defects may be generated in the mechanical properties and pore structure of the porous support.

When said pretreating is carried out by the method of dipping the porous support in the pretreatment solution, said dipping may be carried out at 60-85° C. for 2-4 hours, preferably at 63-80° C. for 2.2-3.7 hours, more preferably at 65-75° C. for 2.3-3.5 hours, and most preferably at 68-73° C. for 2.5-3.2 hours.

If any one of the dipping temperature and time is less than the lower limit, chemical reaction of modifying the chemical structure of the porous support cannot be accomplished. On the other hand, if any one of the dipping temperature and time is larger than the upper limit, a lot of defects may be generated in the mechanical properties and pore structure of the porous support.

The plasma treatment may be carried out at an electric power of 30-100 kW for 30 seconds to 30 minutes, preferably at an electric power of 30-100 kW for 30 seconds to 5 minutes.

If any one of the electric power and time of plasma treatment is less than the lower limit, chemical reaction of modifying the chemical structure of the porous support cannot be accomplished. On the other hand, if any one of the electric power and time of plasma treatment is larger than the upper limit, a lot of defects may be generated in the mechanical properties and pore structure of the porous support.

Said pretreating may be carried out by at least one of a method of dipping the porous support in a pretreatment solution and a plasma treatment method, preferably by both methods. Particularly, when both methods are carried out, there is an advantage in that the support can be modified to be hydrophilic with no loss of mechanical properties and ion conductivity thereof. When plasma treatment is carried out after chemical treatment, it is likely that a hydrophilic substance resulting from the chemical treatment is destroyed by plasma. Therefore, it is preferred that said pretreating is carried out by oxidizing the support through plasma treatment first, and then performing modification into a hydrophilic functional group through chemical treatment.

(B) Step of Impregnating Pretreated Porous Support with Polymer Electrolyte Solution Containing Solvent, Surfactant and Hydrocarbon-Based Polymer Electrolyte

Step (B) is a step of impregnating the pretreated porous support with a polymer electrolyte solution containing a solvent, a surfactant and a hydrocarbon-based polymer electrolyte.

The solvent may include at least one organic solvent selected from alcohol, cycloalkanes, methyl pyrrolidone (NMP), dimethylacetamide (DMAC), dimethoxyethane (DME), dimethyl sulfoxide (DMSO) and dimethyl formamide (DMF), preferably methyl pyrrolidone (NMP).

In addition, the solvent may further include cyclohexane, which is preferred in that the porous support shows improved wettability.

When the solvent further includes cyclohexane, the solvent may include cyclohexane in an amount of 10-30 wt %, preferably 13-27 wt %, more preferably 15-25 wt %, and most preferably 17-23 wt %, based on 100 wt % of the total weight of the solvent.

When the content of cyclohexane in the solvent is less than the lower limit, impregnation property may be degraded. On the other hand, when the content of cyclohexane in the solvent is larger than the upper limit, the polymer solution may show reduced solubility.

According to a preferred embodiment of the present disclosure,
(1) The porous support layer has a thickness of 5-12 μm, porosity of 40-85% and a pore size of 0.02-0.5 μm,
(2) Said pretreating is carried out by both a method of dipping the porous support in a pretreatment solution containing at least one of K₂Cr₂O₇ and KClO₄ and a plasma treatment method,
(3) Said dipping is carried out at 68-73° C. for 2.5-3.2 hours,
(4) The plasma treatment is carried out at an electric power of 1-100 kW for 1-30 minutes, and
(5) The solvent further includes cyclohexane, and the solvent may include cyclohexane in an amount of 17-23 wt % based on 100 wt % of the total weight of the solvent.

When all of the conditions according to the above-described preferred embodiment are satisfied, the resultant reinforced composite membrane is particularly preferred in that it satisfies uniformity and mechanical properties (swelling inhibiting ratio, mechanical strength and elongation ratio) to a desired range. However, if any one of the conditions (1) to (5) is not satisfied, it is shown that at least one of uniformity and mechanical properties (swelling inhibiting ratio, mechanical strength, elongation ratio) is degraded rapidly.

The surfactant may include at least one selected from anionic surfactants, cationic surfactant, nonionic surfactants and amphoteric surfactants.

The anionic surfactant may be at least one selected from the group consisting of linear alkylbenzene sulfonates, fatty alcohol ether sulfates and sulfosuccinate esters, preferably a compound represented by the following Chemical Formula 1, and more preferably C₁₂H₂₅C₆H₄SO₃Na.

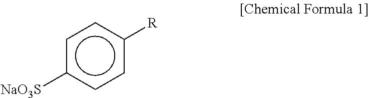

wherein R represents a C₁₀-C₁₃ alkyl group or C₁₀-C₁₃ perfluoroalkyl group.

Particularly, in the compound represented by Chemical Formula 1, it is most preferred that R represents a linear C₁₀-C₁₃ perfluoroalkyl group in terms of maximizing an effect of impregnation with the hydrocarbon-based polymer electrolyte.

The cationic surfactant may be at least one selected from the group consisting of tetraalkylammonium salts, alkylpyridinium salts and imidazolium quaternary ammonium salts, wherein a compound represented by the following Chemical Formula 2 is used preferably since the effect of impregnation with the polymer electrolyte is further increased, C₆H₅CH₂N⁺(CH₃)₂RCl⁻¹ being used more preferably.

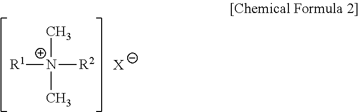

wherein R¹ represents a C₈-C₁₈ alkyl group, R² represents CH₂C₆H₅, and X represents F, Cl, Br or I.

The nonionic surfactant may be at least one selected from the group consisting of alkylphenol ethoxylates, fatty acid ethoxylates and alcohol ethoxylates, wherein a compound represented by the following Chemical Formula 3 is used preferably since the effect of impregnation with the polymer electrolyte is further increased, (C₂H₄O)ₙ C₁₅H₂₄O·n=9-10 being used more preferably.

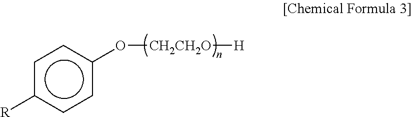

wherein R represents a C₈-C₁₂ alkyl group, and n is an integer of 3-40.

The amphoteric surfactant may be at least one selected from the group consisting of alkyl betaine, alkyl dimethylamine N-oxide and Zwitterion, wherein a compound represented by the following Chemical Formula 4 is used preferably since the effect of impregnation with the polymer electrolyte is further increased, C₂₁H₃₇NO₄S being used more preferably.

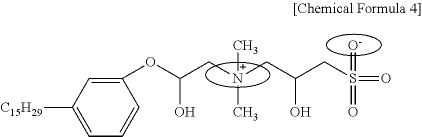

wherein R represents a C₁₃-C₁₉ alkyl group.

The polymer electrolyte solution may include the surfactant in an amount of 0.3-5 wt %, preferably 0.5-4.5 wt %, more preferably 0.7-4 wt %, and most preferably 0.9-3.5 wt %, based on 100 wt % of the total weight of the polymer electrolyte solution.

When the content of the surfactant in the polymer electrolyte solution is less than the lower limit, polymer electrolyte impregnation uniformity may not be as good as expected. On the other hand, when the content of the surfactant in the polymer electrolyte solution is larger than the upper limit, the resultant electrolyte membrane may show degraded mechanical properties and ion conductivity.

The hydrocarbon-based polymer electrolyte may include at least one selected from the group consisting of sulfonated polyphenylene, sulfonated polyimide, sulfonated polyphenylene oxide, sulfonated polyether ether ketone and sulfonated polyethersulfone (SPES), preferably sulfonated polyethersulfone (SPES).

The polymer electrolyte solution may include the hydrocarbon-based polymer electrolyte in an amount of 1-25 wt %, preferably 3-23 wt %, more preferably 5-23 wt %, and most preferably 8-22 wt %, based on 100 wt % of the total weight of the polymer electrolyte solution.

When the content of the hydrocarbon-based polymer in the polymer electrolyte solution is less than the lower limit or is larger than the upper limit, it is not possible to control the step of impregnation with the polymer electrolyte, resulting in degradation of impregnation ratio. As a result, it is likely that a uniform reinforced composite membrane cannot be obtained.

Said impregnating in step (B) may be carried out by at least one method selected from the group consisting of doctor blade, roll coating, bar coating, slot die coating, comma coating, knife coating, gravure coating, microgravure coating, dip coating, flow coating, spin coating and spray coating.

Step (B) may include the steps of: (B1) primarily impregnating the pretreated porous support with the polymer electrolyte solution; and (B2) secondarily impregnating the primarily impregnated porous support with the polymer electrolyte solution.

The primary impregnation may be carried out at 43-60° C. for 2-7 hours, preferably at 44-57° C. for 2.2-6.5 hours, more preferably at 46-55° C. for 2.3-6.2 hours, and most preferably at 48-52° C. for 3-6 hours.

If any one of the temperature and time of the primary impregnation is less than the lower limit or is larger than the upper limit, the polymer electrolyte impregnation ratio may be reduced, resulting in a failure in manufacturing a uniform reinforced composite membrane.

The secondary impregnation may be carried out at 60-80° C. for 8-20 hours, preferably at 63-77° C. for 8-18 hours, more preferably at 65-75° C. for 9-16 hours, and most preferably at 67-73° C. for 10-15 hours.

If any one of the temperature and time of the secondary impregnation is less than the lower limit or is larger than the upper limit, the polymer electrolyte impregnation ratio may be reduced or the polymer electrolyte may be deteriorated, resulting in a failure in manufacturing a uniform reinforced composite membrane.

Particularly, when step (B) is carried out while satisfying all of the temperature and time conditions of the primary impregnation and the temperature and time conditions of the secondary impregnation, even if the resultant reinforced composite membrane is used in a fuel cell or water electrolysis for 3 days or more, it is shown that distribution characteristics of the polymer electrolyte and uniformity are maintained at the same level as the initial stage, which is specifically preferred.

(C) Step of Heat Treating Porous Support Impregnated with Polymer Electrolyte Solution

The method for manufacturing a reinforced composite membrane according to the present disclosure may further include step (C) of heat treating the porous support impregnated with the polymer electrolyte solution, after step (B).

Said heat treating may be carried out at 150-200° C. for 0.5-5 hours, preferably at 155-190° C. for 0.6-4 hours, more preferably at 160-180° C. for 0.7-3 hours, and most preferably at 165-175° C. for 0.8-1.5 hours.

If any one of the temperature and time of said heat treating is less than the lower limit or is larger than the upper limit, the polymer electrolyte impregnation ratio may be reduced or the polymer electrolyte may be deteriorated, resulting in a failure in manufacturing a uniform reinforced composite membrane.

Particularly, although it is not clearly described in the following Examples and Comparative Examples, reinforced composite membranes were manufactured while varying the following conditions in the method for manufacturing a reinforced composite membrane according to the present disclosure, and then the reinforced composite membranes were used to carry out water electrolysis reaction 300 times, current density was determined, and the surface state of each reinforced composite membrane was observed before and after the water electrolysis reaction.

As a result, when all of the following conditions are satisfied, no rapid drop in current density is observed during the 300 times of water electrolysis reaction, and the reinforced composition membrane maintains a deviation of thickness before and after the 300 times of water electrolysis reaction at the same level as the initial stage.

However, if any one of the following conditions is not satisfied, a rapid drop in current density is observed after carrying out water electrolysis reaction 200 times, and the reinforced composite membrane shows an increased deviation of thickness as compared to the initial stage.
\textcircled{1} The surfactant is a compound represented by the following Chemical Formula 1.
\textcircled{2} The polymer electrolyte is sulfonated polyether sulfone (SPES).
\textcircled{3} Step (B) includes the steps of: (B1) primarily impregnating the pretreated porous support with the polymer electrolyte solution; and (B2) secondarily impregnating the primarily impregnated porous support with the polymer electrolyte solution.
\textcircled{4} The primary impregnation is carried out at 48-52° C. for 3-6 hours.
\textcircled{5} The secondary impregnation is carried out at 67-73° C. for 10-15 hours.
\textcircled{6} The method for manufacturing a reinforced composite membrane further includes a step of heat treating the porous support impregnated with the polymer electrolyte solution at 165-175° C. for 0.8-1.5 hours.

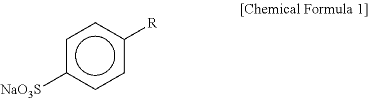

wherein R represents a C₁₀-C₁₃ perfluoroalkyl group.

In another aspect of the present disclosure, there is provided a reinforced composite membrane obtained by the above-described method.

The reinforced composite membrane may include: a porous support pretreated by at least one of a method of dipping in a pretreatment solution containing at least one of K₂Cr₂O₇ and KClO₄ and a plasma treatment method; and a polymer electrolyte solution with which one surface or both surfaces of the porous support are impregnated and which contains a solvent, a surfactant and a hydrocarbon-based polymer electrolyte.

The reinforced composite membrane may have a thickness of 5-200 μm, preferably 5-100 μm.

When the reinforced composite membrane has a thickness of less than the lower limit, it may have degraded mechanical properties. On the other hand, when the reinforced composite membrane has a thickness of larger than the upper limit, it may show degraded electrochemical performance.

In still another aspect of the present disclosure, there is provided a water electrolyte bath including the reinforced composite membrane.

In still another aspect of the present disclosure, there is provided a fuel cell including the reinforced composite membrane.

In yet another aspect of the present disclosure, there is provided a device including the fuel cell, the device being any one selected from communication devices, transport devices and energy storage devices.

Hereinafter, the present disclosure will be described in more detail through Examples, etc., but the scope and contents of the present disclosure cannot be reduced or limited by the following Examples, etc.

### Example 1. Pretreatment A

### Pretreatment of Porous Support (A)

A porous support (thickness: 6 μm, porosity: 80%, average diameter of pores: 0.23 μm) made of polytetrafluoroethylene (PTFE) was treated with plasma at an electric power of 100 kW for 1 minute to prepare a pretreated porous support (PTFE-A).

### Polymer Electrolyte Solution

A polymer electrolyte solution of sulfonated polyether sulfone (SPES) was prepared by using dimethyl sulfoxide (DMSO) as a solvent. Herein, the content of SPES in the resultant polymer electrolyte solution was 10 wt % based on 100 wt % of the total weight of the polymer electrolyte solution.

### Manufacture of Reinforced Composite Membrane

The porous support (PTFE-A) was located on a glass substrate. Then, the porous support (PTFE-A) was primarily impregnated with the polymer electrolyte solution by using a doctor blade at 50° C. for 6 hours, and then secondarily impregnated with the polymer electrolyte solution by using a doctor blade at 70° C. for 12 hours. After that, heat treatment was carried out at 170° C. for 1 hour to obtain a reinforced composite membrane having a thickness of 25 μm.

### Example 2. Pretreatment B

### Pretreatment of Porous Support (B)

A porous support (thickness: 6 μm, porosity: 80%, average diameter of pores: 0.23 μm) made of polytetrafluoroethylene (PTFE) was subjected to a wet chemical treatment process by dipping it in a pretreatment solution containing 3 wt % of KClO₄ at 70° C. for 3 hours to prepare a pretreated porous support (PTFE-B).

Then, a reinforced composite membrane having a thickness of 25 μm was obtained in the same manner as Example 1, except that the porous support (PTFE-B) was used instead of the porous support (PTFE-A) prepared according to Example 1.

### Example 3. Pretreatment A+Surfactant

A reinforced composite membrane was obtained in the same manner as Example 1, except that polyoxyethylene (9) nonylphenylether (branched alkylphenol ethoxylate) as a surfactant was further added in an amount of 1.1 wt % to the polymer electrolyte solution.

### Example 4. Pretreatment B+Surfactant

A reinforced composite membrane was obtained in the same manner as Example 2, except that polyoxyethylene (9) nonylphenylether (branched acylphenol ethoxylate) as a surfactant was further added in an amount of 1.1 wt % to the polymer electrolyte solution.

### Example 5. Pretreatment A+Surfactant+Impregnation Promoter

A reinforced composite membrane was obtained in the same manner as Example 3, except that a mixture containing dimethyl sulfoxide (DMSO) and cyclohexane mixed at a weight ratio of 8:2 was used as a solvent of the polymer electrolyte solution.

### Example 6. Pretreatment B+Surfactant+Impregnation Promoter

A reinforced composite membrane was obtained in the same manner as Example 4, except that a mixture containing dimethyl sulfoxide (DMSO) and cyclohexane mixed at a weight ratio of 8:2 was used as a solvent of the polymer electrolyte solution.

### Example 7. Pretreatment A+Anionic Surfactant+NMP

A reinforced composite membrane was obtained in the same manner as Example 3, except that N-methyl-2-pyrrolidone (NMP) was used as a solvent of the polymer electrolyte solution, and sodium decylbenzenesulfonate (linear alkylbenzene sulfonate) represented by the following Chemical Formula 5 was used as a surfactant.

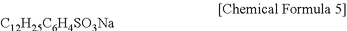

### Example 8. Pretreatment A+Cationic Surfactant+NMP

A reinforced composite membrane was obtained in the same manner as Example 7, except that benzalkonium chloride (tetraalkylammonium salt) represented by the following Chemical Formula 6 was used as a cationic surfactant instead of the anionic surfactant.

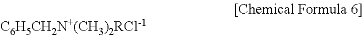

### Example 9. Pretreatment A+Nonionic Surfactant+NMP

A reinforced composite membrane was obtained in the same manner as Example 7, except that polyoxyethylene (9)nonylphenylether (branched alkylphenol ethoxylate) represented by the following Chemical Formula 7 was used as a nonionic surfactant instead of the anionic surfactant.

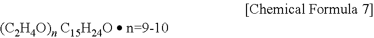

### Example 10. Pretreatment A+Amphoteric Surfactant+NMP

A reinforced composite membrane was obtained in the same manner as Example 7, except that 3-(4-heptyl)phenyl-3-hydroxypropyl)dimethylammoniopropane sulfonate (zwitterion) represented by the following Chemical Formula 8 was used as an amphoteric surfactant instead of the anionic surfactant.

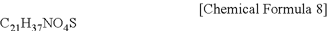

### Comparative Example 1

The same porous support as Example 1 (thickness: 6 μm, porosity: 80%, average diameter of pores: 0.23 μm), made of polytetrafluoroethylene (PTFE), was prepared with no pretreatment.

### Comparative Example 2

A reinforced composite membrane having a thickness of 25-30 μm was obtained in the same manner as Comparative Example 1, except that polyoxyethylene (9) nonylphenylether (branched alkylphenol ethoxylate) as a surfactant was further added in an amount of 1.1 wt % to the polymer electrolyte solution.

### Comparative Example 3

A reinforced composite membrane having a thickness of 25-30 μm was obtained in the same manner as Comparative Example 2, except that a mixture containing dimethyl sulfoxide (DMSO) and cyclohexane mixed at a weight ratio of 8:2 was used as a solvent of the polymer electrolyte solution.

### Comparative Example 4

A reinforced composite membrane having a thickness of 25-30 μm was obtained in the same manner as Comparative Example 1, except that N-methyl-2-pyrrolidoen (NMP) was used as a solvent of the polymer electrolyte solution.

TABLE 1

| | | Polymer electrolyte solution | | |
|---|---|---|---|---|
| | | | | Content of |
| | Pretreat- | | | polymer |
| | ment | Surfactant | Solvent | electrolyte(%) |
| Ex. 1 | Plasma | X | DMSO | 10 |
| Ex. 2 | Chemical | X | DMSO | 10 |
| Ex. 3 | Plasma | Nonionic | DMSO | 10 |
| | | (Chemical | | |
| | | Formula 7) | | |
| Ex. 4 | Chemical | Nonionic | DMSO | 10 |
| | | (Chemical | | |
| | | Formula 7) | | |
| Ex. 5 | Plasma | Nonionic | DMSO + | 10 |
| | | (Chemical | Cyclohexane | |
| | | Formula 7) | (8:2) | |
| Ex. 6 | Chemical | Nonionic | DMSO + | 10 |
| | | (Chemical | Cyclohexane | |
| | | Formula 7) | (8:2) | |
| Ex. 7 | Plasma | Anionic | NMP | 10 |
| | | (Chemical | | |
| | | Formula 5) | | |
| Ex. 8 | Plasma | Cationic | NMP | 10 |
| | | (Chemical | | |
| | | Formula 6) | | |
| Ex. 9 | Plasma | Nonionic | NMP | 10 |
| | | (Chemical | | |
| | | Formula 7) | | |
| Ex. 10 | Plasma | Amphoteric | NMP | 10 |
| | | (Chemical | | |
| | | Formula 8) | | |
| Comp. | X | X | DMSO | 10 |
| Ex. 1 | | | | |
| Comp. | X | Nonionic | DMSO | 10 |
| Ex. 2 | | (Chemical | | |
| | | Formula 7) | | |
| Comp. | X | Nonionic | DMSO + | 10 |
| Ex. 3 | | (Chemical | Cyclohexane | |
| | | Formula 7) | (8:2) | |
| Comp. | X | X | NMP | 10 |
| Ex. 4 | | | | |

### Test Example 1. Evaluation of Physical Properties of Porous Support Depending on Pretreatment

### Evaluation of Porosity

Non-treated PTFE and the pretreated porous supports prepared according to Example 1 (PTFE-A) and Example 2 (PTFE-B) were determined in terms of pore size. The results are shown in the following Table 2.

TABLE 2

| Sample | Support Pore size (μm) |
|---|---|
| PTFE | 0.241 |
| PTFE-A | 0.235 |
| PTFE-B | 0.232 |

As shown in Table 2, both pretreatment methods show a decrease in porosity of approximately 10%, which is not significantly different from the porosity of the original support.

### Evaluation of Water Contact Angle

PTFE, the pretreated porous support prepared according to Example 1 (PTFE-A) and the pretreated porous supports prepared according to Example 2 (PTFE-B) were determined in terms of water contact angle depending on time. The results are shown in FIG. 2 to FIG. 4.

FIG. 2 shows a water contact angle of non-treated polytetrafluoroethylene (PTFE), that of the pretreated porous support (PTFE-A) obtained according to Example 1 of the present disclosure, and that of the pretreated porous support obtained according to Example 2, depending on time.

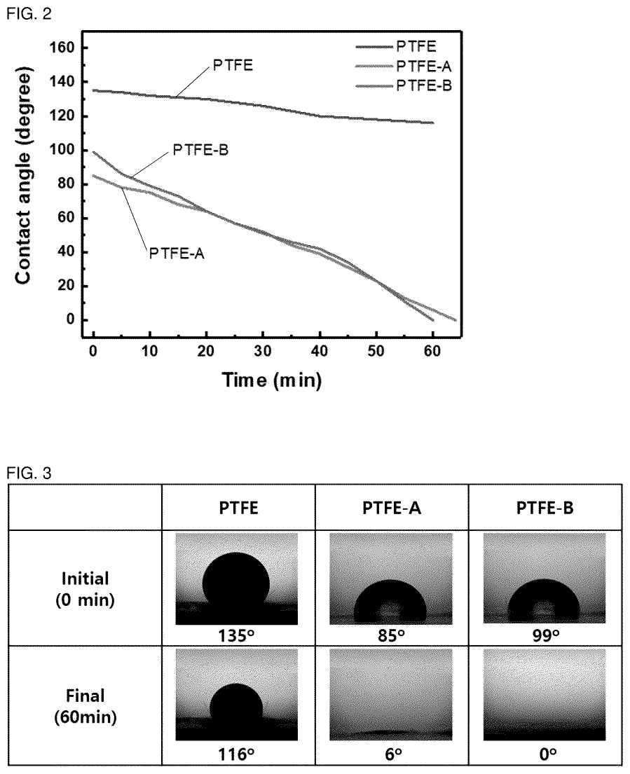

FIG. 3 shows an image for measuring a water contact angle of non-treated polytetrafluoroethylene (PTFE), that of the pretreated porous support (PTFE-A) obtained according to Example 1 of the present disclosure, and that of the pretreated porous support obtained according to Example 2, at the initial stage (0 min) and after 60 minutes.

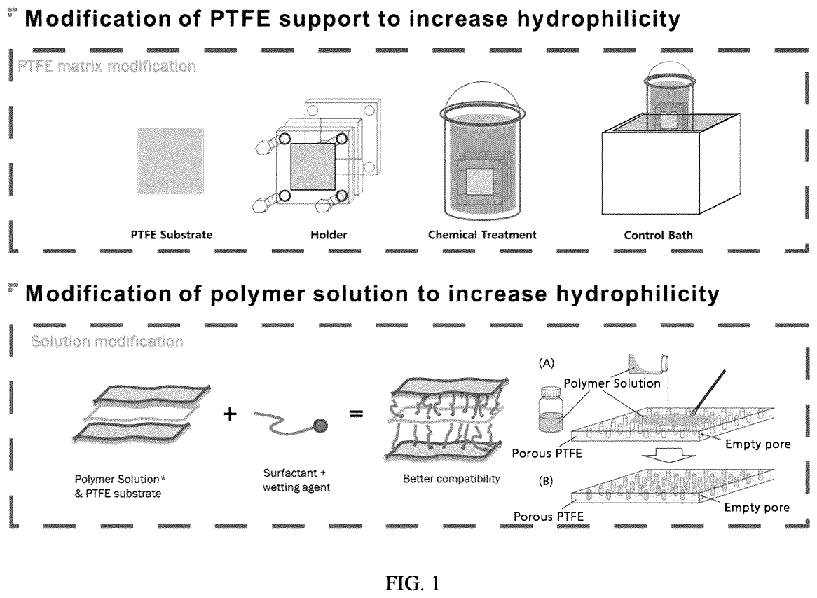

As shown in FIG. 1 to FIG. 3, the PTFE supports pretreated chemically according to Examples 1 and 2 show a significant decrease in contact angle, which suggests improvement of hydrophilicity.

### Test Example 2. Shape of Reinforced Composite Membrane Depending on Pretreatment of Porous Support and Use of Surfactant

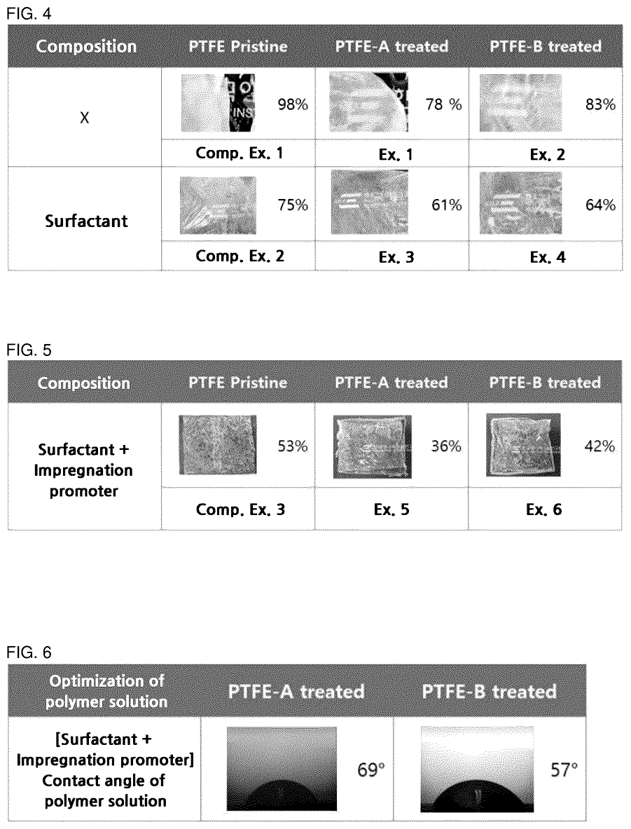

FIG. 4 shows a photographic image and haziness of the reinforced composite membrane obtained according to each of Comparative Examples 1 and 2 and Examples 1 to 4 of the present disclosure.

As shown in FIG. 4, the reinforced composite membranes using no surfactant in the polymer electrolyte solution according to Comparative Example 1 and Examples 1 and 2 show a haziness of 70% or higher, which suggests low impregnation properties. On the other hand, the reinforced composite membranes using a polymer electrolyte solution containing a surfactant added thereto according to Examples 3 and 4 show a haziness of less than 70%, which suggests low cloudy/hazy properties. In addition, it can be seen that Comparative Example 2 in which the porous support is subjected no pretreatment still shows a high haziness of 75%, while the reinforced composite membranes according to Examples 3 and 4 show a low haziness value.

### Test Example 3. Optimization of Composition of Polymer Solution

To determine the impregnation property depending on the type of a polymer electrolyte solution, a reinforced composite membrane further using an impregnation promoter was analyzed in terms of an image observed by the naked eyes and haziness. The results are shown in FIG. 5.

FIG. 5 shows a photographic image and haziness of the reinforced composite membrane obtained according to each of Comparative Example 3 and Examples 5 and 6 of the present disclosure.

As shown in FIG. 5, in the case of the reinforced composite membrane according to each of Examples 5 and 6 and Comparative Example 3, impregnation with the polymer solution is accelerated by using an impregnation promoter to provide a significantly increased impregnation ratio and low haziness value. Particularly, only Examples 5 and 6 using a pretreated porous support show a significantly low haziness value of 40% or less.

FIG. 6 shows the result of measuring a contact angle to determine the wettability of PTFE with the polymer solution prepared from each of Examples 5 and 6 of the present disclosure.

As shown in FIG. 6, it can be seen that optimizing the composition of a polymer solution causes a decrease in contact angle, resulting in improvement of wettability and an increase in polymer impregnation ratio.

### Test Example 4. Evaluation of Properties of Polymer Electrolyte Solution Depending on Type of Surfactant

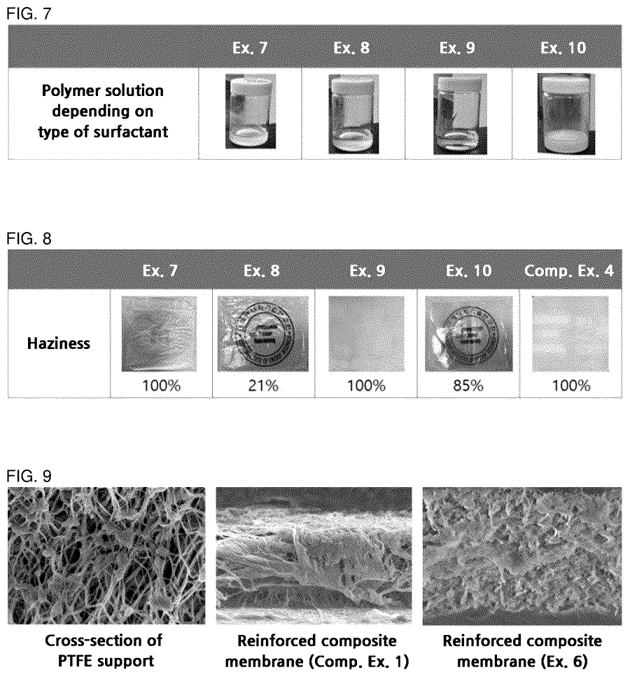

The photographic images of the polymer electrolyte solutions using a different type of surfactant and different content of polymer electrolyte according to Examples 7 to 10 are shown in FIG. 7, and the corresponding reinforced composite membranes and haziness values thereof are shown in FIG. 8.

FIG. 7 shows a photographic image of the polymer electrolyte solution according to each of Examples 7 to 10 of the present disclosure.

As shown in FIG. 7, after comparing the solubility of an impregnation promoter in SPES 50 polymer solution, it can be seen that use of a nonionic promoter provides highest uniformity with no phase separation.

FIG. 8 shows a photographic image and haziness of the reinforced composite membrane according to each of Examples 7 to 10 and Comparative Example 4 of the present disclosure.

As shown in FIG. 8, after manufacturing reinforced composite membranes using different impregnation promoters, it can be seen that use of a nonionic promoter provides highest uniformity with no phase separation.

### Test Example 5. Cross-Sectional Analysis of Reinforced Composite Membrane and Determination of Ion Conductivity

FIG. 9 shows a scanning electron microscopic (SEM) image of the reinforced composite membrane according to each of Example 6 and Comparative Example 1 of the present disclosure and PTFE.

As shown in FIG. 9, it can be seen that the non-treated PTFE has a network structure having randomly arranged pores, but the pores are filled well after the impregnation with a polymer. It can be also seen that the cross-sectional image of Example 6 in which the composition of polymer solution is optimized shows a structure having pores filled better with the polymer electrolyte.

Meanwhile, the reinforced composite membranes according to Examples 2 and 6 and Comparative Example 1 were determined in terms of ion conductivity. The results are shown in the following Table 3.

TABLE 3

| | | Temperature | Thickness | Conductivity |
|---|---|---|---|---|
| No. | Membrane | (° C.) | (μm) | (S/cm) |
| 1 | Comp. Ex. 1 | 25 | 25 ± 2 | 0.035 |
| 2 | Ex. 2 | 25 | 25 ± 2 | 0.037 |
| 3 | Ex. 6 | 25 | 25 ± 2 | 0.049 |

As shown in Table 3, it can be seen that as the polymer impregnation ratio is improved by using a surfactant and optimizing the composition of a polymer solution, the reinforced composite membrane has improved ion conductivity.

The present disclosure has been described in detail with reference to specific examples. However, it should be understood by those skilled in the art that the various changes and modifications can be without departing from the scope of the present disclosure defined by the following claims through the addition, modification, elimination or supplement of a constitutional element, and that such changes and modifications also fall within the scope of the present disclosure.

What is claimed is:

1. A method for manufacturing a reinforced composite membrane, comprising the steps of:
(A) pretreating a porous support; and
(B) impregnating the pretreated porous support with a polymer electrolyte solution containing a solvent and a hydrocarbon-based polymer electrolyte,
wherein the polymer electrolyte solution optionally further comprises a surfactant, and
said pretreating is carried out by at least one of a method of dipping the porous support in a pretreatment solution containing at least one of K₂Cr₂O₇ and KClO₄ and a plasma treatment method.

2. The method for manufacturing a reinforced composite membrane according to claim 1, wherein said pretreating in step (A) is carried out by dipping the porous support in a pretreatment solution containing at least one of K₂Cr₂O₇ and KClO₄, and said dipping is carried out at 60-85° C. for 2-4 hours.

3. The method for manufacturing a reinforced composite membrane according to claim 1, wherein said pretreating in step (A) is carried out by treating the porous support with plasma, and the plasma treatment is carried out at an electric power of 30-100 kW for 30 seconds to 30 minutes.

4. The method for manufacturing a reinforced composite membrane according to claim 1, wherein the solvent further comprises cyclohexane.

5. The method for manufacturing a reinforced composite membrane according to claim 1, wherein the surfactant comprises at least one selected from anionic surfactants, cationic surfactant, nonionic surfactants and amphoteric surfactants.

6. The method for manufacturing a reinforced composite membrane according to claim 1, wherein the surfactant comprise at least one of compounds represented by the following Chemical Formula 1 to Chemical Formula 4: 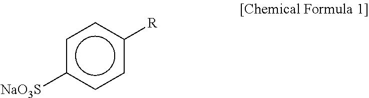
wherein R represents a C₁₀-C₁₃ alkyl group or C₁₀-C₁₃ perfluoroalkyl group, 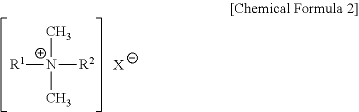
wherein R¹ represents a C₈-C₁₈ alkyl group, R² represents CH₂C₆H₅, and X represents F, Cl, Br or I, 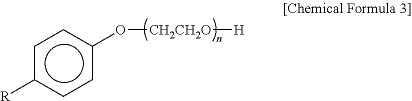
wherein R represents a C₈-C₁₂ alkyl group, and n is an integer of 3-40, 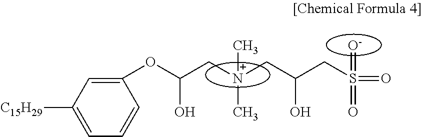
wherein R represents a C₁₃-C₁₉ alkyl group.

7. The method for manufacturing a reinforced composite membrane according to claim 1, wherein the polymer electrolyte solution comprises the surfactant in an amount of 0.3-5 wt %, based on 100 wt % of the total weight of the polymer electrolyte solution.

8. The method for manufacturing a reinforced composite membrane according to claim 1, wherein the hydrocarbon-based polymer electrolyte comprises at least one selected from the group consisting of sulfonated polyphenylene, sulfonated polyimide, sulfonated polyphenylene oxide, sulfonated polyether ether ketone and sulfonated polyethersulfone (SPES).

9. The method for manufacturing a reinforced composite membrane according to claim 1, wherein the polymer electrolyte solution comprises the hydrocarbon-based polymer electrolyte in an amount of 1-25 wt %, based on 100 wt % of the total weight of the polymer electrolyte solution.

10. The method for manufacturing a reinforced composite membrane according to claim 1, wherein step (B) comprises the steps of:
(B1) primarily impregnating the pretreated porous support with the polymer electrolyte solution; and
(B2) secondarily impregnating the primarily impregnated porous support with the polymer electrolyte solution.

11. The method for manufacturing a reinforced composite membrane according to claim 1, which further comprises step (C) of heat treating the porous support impregnated with the polymer electrolyte solution, after step (B).

12. A reinforced composite membrane obtained by the method as defined in any one of claims 1 to 11.

13. A water electrolysis bath comprising the reinforced composite membrane as defined in claim 12.

14. A fuel cell comprising the reinforced composite membrane as defined in claim 12.

15. A device comprising the fuel cell as defined in claim 14, the device being any one selected from communication devices, transport devices and energy storage devices.
